(19) United States
(12) Patent Application Publication
(10) Pub. No.: US 2005/0227000 A1
(43) Pub. Date: Oct. 13, 2005

(54) Surface coating solution

(75) Inventors: Ralph Bauer, Niagara Falls (CA); Doruk Yener, Shrewsbury, MA (US); Douglas Bellfy, Rutland, MA (US)

Correspondence Address: TOLER & LARSON & ABEL L.L.P., 5000 PLAZA ON THE LAKE STE 265, AUSTIN, TX, 78746, US

(73) Assignee: Saint-Gobain Ceramics & Plastics, Inc.

(21) Appl. No.: 10/823,400

(22) Filed: Apr. 13, 2004

(51) Int. Cl. B41M 5/00; B05D 1/12; A23L 1/00

(52) U.S. Cl. 427/180; 106/400; 426/627

(57) ABSTRACT

The disclosure describes a surface coating solution having a surface coating base and boehmite particles provided in the surface coating base. The boehmite particles comprise mainly anisotropically shaped particles having an aspect ratio of at least 3:1.

### TECHNICAL FIELD OF THE DISCLOSURE

This disclosure relates to surface coating solutions and methods for forming same, and in particular, surface coating solutions containing boehmite.

### BACKGROUND

Surface coating solutions are useful in various applications including paints, surface protectants, and adhesive solutions. Such coatings may be applied through various application techniques, including spraying, dip coating, and brushing or rolling, and are generally formulated to optimize the intended technique. Improper formulation may lead to undesired texture, application markings, and sag or dripping of the surface coating solution during application. Such issues are of particular significance in water-based coating formulations, such as latex surface coating solutions.

An example of a latex coating formulation is provided in U.S. Pat. No. 5,550,180. The latex formulation or composition includes as a rheology modifier, boehmite alumina having a crystal size (020 plane) less than about 60 angstroms and a surface area, when calcined to gamma phase, of greater than approximately 200 m²/g. The boehmite is present in an amount to modify rheological properties of the composition, to have a relatively high viscosity at low-shear and a lower viscosity at high-shear.

Despite advances in formulation of surface coating solutions, a need continues to exist in the art for cost effective surface coating solutions having desirable sag resistance, flow and leveling characteristics, and viscosity recovery times. As such, improved surface coating solutions are desirable.

### SUMMARY

One embodiment of the present invention is directed to a surface coating solution having a surface coating base and boehmite particles provided in the surface coating base. The boehmite particles comprise mainly anisotropically shaped particles having an aspect ratio of at least 3:1.

Another embodiment of the present invention is directed to a surface coating solution comprising boehmite particles comprising mainly anisotropically shaped particles having an aspect ratio of at least 3:1 and a longest dimension of at least 50 nanometers.

A method of forming a surface coating preparation is also provided. The method includes activating boehmite particles to form an active solution, forming a grind solution using the active solution, and forming a coating preparation using the grind solution. The boehmite particles comprise mainly anisotropically shaped particles. Surface coating preparations formed by the foregoing method are also described.

### BRIEF DESCRIPTION OF THE DRAWINGS

FIG. 1 depicts rheology stability for exemplary embodiments of coating solutions.

FIG. 2 depicts shear dependent viscosity behavior for exemplary coating solutions.

FIG. 3 depicts Laneta sag resistance for exemplary coating solution.

### DETAILED DESCRIPTION

According to one embodiment of the present invention, a coating solution is provided that includes a coating base and boehmite particles provided in the coating base. The boehmite particles are generally composed of mainly anisotropically shaped particles having an aspect ratio of at least 3:1, and include needle-shaped and platelet-shaped particles, and combinations thereof. The coating solution may have properties such as sag resistance or flow and leveling characteristics desirable for particular applications.

The coating solution and coating base may be water-based or oil-based solutions, such as paints, enamels, surface coatings and adhesives. Water based solutions include latex paints, such as acrylic emulsions, styrene modified acrylic emulsions, and polyvinyl acetate emulsions. Oil-based solutions may include alkyd resins, such as oil-modified polyesters and solvent-based alkyds. In addition, the coating solution and coating base may be a water reducible alkyd solution. The coating solution may be useful for indoor and outdoor applications, and include architectural or light industrial maintenance coatings.

The term “boehmite” is generally used herein to denote alumina hydrates including mineral boehmite, typically being Al₂O₃.H₂O and having a water content on the order of 15%, as well as psuedoboehmite, having a water content higher than 15%, such as 20-38% by weight. Although technically psuedoboehmite generally has more than 1 mole of water per mole of alumina, often times the literature uses the term alumina monohydrate to describe psuedoboehmite. Accordingly, the term alumina monohydrate is used herein to include psuedoboehmite. Alumina monohydrate particles may be used in a colloidal form, herein termed colloidal alumina monohydrate (CAM) particles. The boehmite particles include mainly anisotropically shaped particles, such as needle-like or platelet-like particles, which are generally dispersed in the coating base.

One exemplary embodiment utilizes boehmite particles comprising anisotropic, needle-shaped crystals having a longest dimension of at least 50 nanometers, preferably from 50 to 2000, and more preferably from 100 to 1000 nanometers. The dimensions perpendicular to the length are typically each less than 50 nanometers. The aspect ratio, defined as the ratio of the longest dimension to the next longest dimension perpendicular to the longest dimension, is generally at least 3:1, and preferably at least 6:1. Additionally, the needle-shaped particles may be characterized by a secondary aspect ratio defined as the ratio of the second longest dimension to the third longest dimension. The secondary aspect ratio is generally no more than 3:1, typically no more than 2:1, and oftentimes about 1:1. The secondary aspect ratio generally describes the cross-sectional geometry of the particles in a plane perpendicular to the longest dimension.

Needle-shaped particles may be fabricated by extended hydrothermal conditions combined with relatively low seeding levels and acidic pH, resulting in preferential growth of boehmite along one axis. Longer hydrothermal treatment may be used to produce even longer and higher aspect ratio needle-shaped boehmite particles. The needle-shaped particles have a surface area, as measured by the BET technique, of at least 75 m²/g, and preferably at least 100 m²/g, such as up to 250, 300, or even 350 m²/g. Such needle-shaped particles may be formed through the process described in commonly owned U.S. Published Application No. 2003/0197300 A1, incorporated herein by reference.

While certain embodiments utilize the above-described needle-shaped boehmite particles, others use platelet-shaped boehmite particles. Platelet-shaped particles are generally crystals having a face dimension of at least 50 nanometers, preferably from 50 to 2000 nanometers, and more preferably from 100 to 1000 nanometers. The edge dimensions perpendicular to the face are generally less than 50 nanometers. The aspect ratio, defined as the ratio of the longest dimension to the next longest dimension perpendicular to the longest dimension, is at least 3:1, and preferably at least 6:1. Further, the opposite major surfaces of the particles are generally planar and are generally parallel to each other, further defining the platelet morphology of the particles. In addition, the platelet-shaped particles may be characterized as having a secondary aspect ratio greater than about 3:1. The platelet-shaped particles generally have surface areas, as measured by the BET technique, of at least 10 m²/g, and preferably from 70 to 90 m²/g.

The platelet-shaped particles may be produced by hydrothermal treatment of aluminum trihydroxide raw material loaded with boehmite seed crystals. As a working example, an autoclave was charged with 7.42 lb of Alcoa Hydral 710 aluminum trihydroxide; 0.82 lb of SASOL Catapal B pseudoboehmite; 66.5 lb of deionized water; 0.037 lb potassium hydroxide; and 0.18 lb of 22 wt % nitric acid. The boehmite was pre-dispersed in 5 lb of the water and 0.18 lb of the acid before adding to the aluminum trihydroxide, remaining water, and potassium hydroxide. The autoclave was heated to 185° C. over a 45 minute period and maintained at that temperature for 2 hours while stirring at 530 rpm. An autogenously generated pressure of about 163 psi was reached and maintained. Thereafter, the boehmite dispersion was removed from the autoclave and the liquid content was removed at a temperature of 65° C. The resultant mass was crushed to less than 100 mesh.

The boehmite particles may be individually and uniformly dispersed within the coating solution containing polar solvents and/or polymers without specialized surface treatment of the boehmite particles to increase dispersion. However, surface treatments may impart unique properties of the solution, such as modification of rheology, and are accordingly desirable for certain applications. For example, water-based solutions containing surface-treated boehmite particles may exhibit a high low-shear viscosity and a comparatively lower high-shear viscosity, the spread in high and low viscosity levels at the different shear conditions being greater than solutions containing un-treated boehmite particles. Boehmite particle surface treatments may include addition of alkali and alkali earth sulfates, such as magnesium sulfate and calcium sulfate, and ammonium compounds, such as ammonium hydroxide. In one exemplary embodiment, the high-shear viscosity is not greater than 50% of the low shear viscosity, such as not greater than 30% of the low-shear viscosity. The low-shear viscosity may, for example, be measured at 10 rpm and the high-shear viscosity measured at 100 rpm.

In solution, the boehmite particles, such as in the form of colloidal alumina monohydrate (CAM) particles, may constitute between about 0.1% and 20% by weight of the coating solution. For example, the boehmite particles may constitute between about 0.5% and 10% by weight of the coating solution or, in another example, between about 0.5% and 2% by weight of the coating solution. The solution may have a basic pH such as a pH greater than 7, for example, the pH may be at least about 7.5, 8.0, or higher.

The coating solution may also include water-based thickeners such as clays (e.g., nanoclay Actigel-208), hydroxy ethyl cellulose (HEC), modified HEC, and other water-based rheological modifiers. However, according to a particular embodiment, the coating solution is free of associative thickeners, such as QR-708. Associative thickeners are those components that associate with polymers in the solution, such as by forming complexes with the polymers.

With the above loading of anisotropically shaped boehmite particles, the coating solution may have desirable characteristics such as sag resistance, flow and leveling characteristics, and recovery times. The Laneta sag resistance, as measured using test method ASTM D4400, may be between 7 and 12 mils. In exemplary embodiments, the Laneta sag resistance was measured to be between 8 and 10 mils. The flow and leveling characteristic as measured using test method ASTM D2801, is generally greater than 6 mils. In exemplary embodiments, the flow and leveling characteristic was between about 6 and 10 mils, such as between about 6 and 7 mils. Recovery times may be characterized by the viscosity of the coating solution. According to one embodiment, the coating solution recovers 80% of low-shear viscosity (10 rpm) in less than about 15 seconds

Dry times were measured using test method ASTM D1640. The coating solution generally has a Set-to-Touch dry time of less than 30 minutes. In exemplary embodiments, the Set-to-Touch dry time was measured to be between 8 and 15 minutes, such as between 8 and 10 minutes.

Turning to solution formation, the coating solution may be formed through activating a solution of boehmite particles, such as colloidal alumina monohydrate (CAM) particles, to form an active solution. Activating the solution generally results in a shear thinning solution, such as a solution that exhibits the Theological trend described in Example 1 below. One possible mechanism for the activation of the solution and attendant modification of rheology, is modification of surface properties of the boehmite particles, such as through formation of salts with surface nitrates located on the boehmite particles. In one embodiment, adding amines activates the particles. For example, ammonium hydroxide may be added to the solution to increase the pH and activate the boehmite particles. This is believed to result in the formation of a soluble quaternary ammonium salt with residual nitric acid found in samples. Alternately, alkli and alkli earth metal salts may be used, such as magnesium sulfate and calcium sulfate, to activate the boehmite solution. In another example, thickening clays, such as nanoclays may be added to activate the boehmite particles. In a further embodiment, colloidal silica is added to activate the boehmite particles. Activation may be carried out by adding substrate particles having surface charge opposite that of the boehmite particles (e.g., colloidal silica is negatively charged, thereby interacting with positively charged boehmite particles). The particular example of ammonium hydroxide may be beneficial in latex emulsion-based solutions by improving formulation stability, and accordingly, is desirable in the context of certain latex coating solutions.

The efficacy of activation may be affected by the particular manner in which activation is carried out. According to one embodiment, boehmite is added to the solvent base prior to introduction of an activator. For example a boehmite is first added to water, followed by introduction of ammonium hydroxide. This technique resulted in a higher viscosity and better stability of the solution than a different ordering of steps, namely addition of ammonium hydroxide first to the aqueous solution, followed by the boehmite introduction.

The activated CAM solution may be used to form a grind solution. The term grind solution generally means an intermediate solution having a high concentration of pigment and other active components. The grind solution is generally prepared with ingredients that are robust and can hold up to high shear rates used during formulation of the grind solution, and typically includes defoamers, pigments, pigment dispersants and wetting agents. Blend partners, such as fillers, may also be added to the grind solution or before the preparation of the grind solution. Blend partners may include glass fibers, aluminum trihydrate, sub-micron alpha alumina particles, silica, and carbon. The grind solution is generally diluted to form a surface coating preparation, which combines the grind solution, additional solvent, and a suspension of polymeric particles, such as latex or acrylic particles. Typically, shear sensitive ingredients (e.g., fragile components that do not withstand high shear conditions) are added during the preparation of the surface coating preparation. One exemplary paint emulsion is Maincote HG-56 gloss white enamel standard by Rohm & Haas.

### EXAMPLES

The following examples utilize boehmite particles formed by seeding a solution with 10% by weight seed particles, herein referred to as CAM 9010.

### Example 1

A vessel was charged with 270 grams of tap water having a pH of 8.04. Thirty (30) grams of CAM 9010 were added and agitated for 15 minutes. The pH of the solution fell to 4.41. Ammonium hydroxide was added to the above mixture until thickening was observed. Ammonium hydroxide was the volatile amine of choice in the example, as it is commonly used in water-based emulsion coatings. Thickening, or gel formation, was produced after a 0.56 gram addition of 28% ammonium hydroxide. The quantity of ammonium hydroxide equated to a level of 0.187% based on total weight, or 1.87% based on boehmite weight. The resulting “activated” 10% CAM 9010 pre-gel had a pH of 7.29. Low to high shear viscosities of this blend, and relative recovery rate after 15 seconds, were as follows:

| Spindle/RPM | cps |
|---|---|
| #6 @ 10 | 23,000 |
| #6 @ 100 | 3,950 |
| #6 @ 10 after 15 sec. recovery | 19,500 |

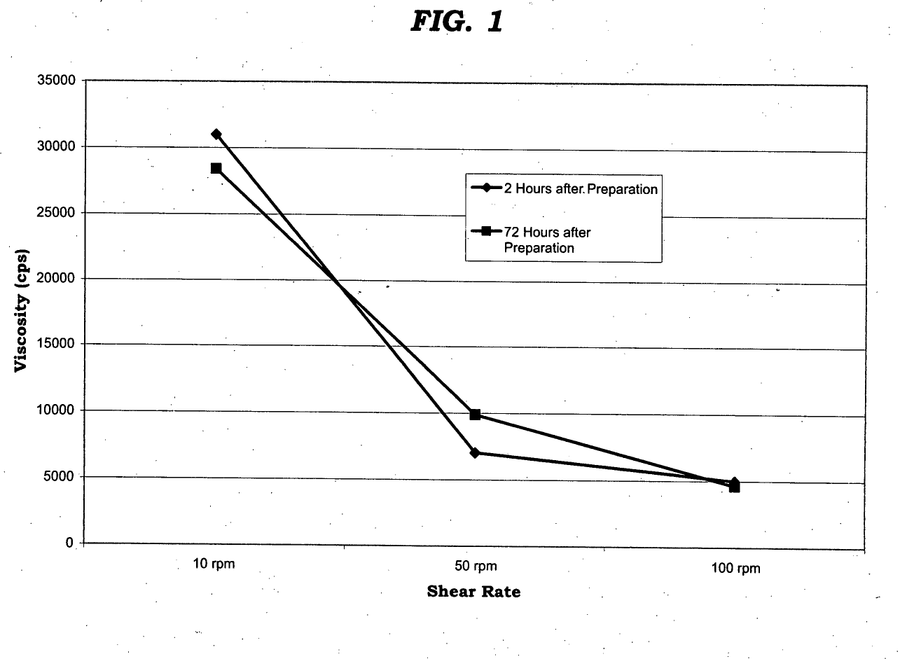

It is believed that the ammonium hydroxide reacts with residual nitric acid on the boehmite particle surfaces to produce the increased pH and viscosity of the solution. FIG. 1 depicts the rheology profile at 2 to 72 hours after preparation. The solution rheology is stable in a 72 hour period.

### Example 2

The polymer system selected for study was Rohm & Haas' Maincote HG-56, an acrylic emulsion designed for the preparation of primers and weatherable topcoats for light to moderate duty industrial maintenance applications. The Maincote HG-56 formulation chosen to serve as a standard for comparison and a baseline for test formulations was the R& H starting point formulation, G-46-1. Gloss White Enamel for Spray Application. The manufacturer recommends the use of Acrysol QR-708 for thickening of this formulation at a level of 2 lbs per 100 gallons of coating.

Solutions where tested using a thickener composition of 100% CAM 9010, blends of CAM 9010 with a nanoclay, or 100% Acrysol QR-708. Blends of CAM and nanoclay utilize a portion of the CAM's inherent acidity and the pigment dispersant to activate the nanoclay. Tamol 850, an ammonium salt, was tested and provided partial activation of the nanoclay. Tamol 731, a sodium salt, was also tested and worked significantly better. The nanoclay activates when metal sources such as sodium, calcium, or potassium are present.

The CAM 9010 was readily activated by the ammonium hydroxide addition in the formulation selected. One pound of ammonium hydroxide was used in the formulation for stability and was more than sufficient to activate even the highest loading levels of the CAM 9010 evaluated.

Final coating preparation was initiated using 20 pounds of total thickener. Boehmite, in an amount indicated below as a percentage of 20 pounds, was added to 123.2 pounds of deionized water. One pound of 28% ammonium hydroxide solution was added to the solution. Subsequently, a nanoclay thickener was added to form the remainder of the thickener blend. In addition, 1.5 pounds of Drew L405 defoamer, 11.1 pounds of Tamol 731 pigment dispersant, 1.5 pounds of Triton CF-10 pigment wetting agent, and 195 pounds of Ti-Pure R-706 rutile titanium dioxide were added. This formed the grind solution, which was added to a coating preparation including 523 pounds of Maincote HG-56, 4 pounds of 28% ammonium hydroxide solution, 40 pounds of benzyl alcohol, 15 pounds of dibutyl phthalate, 2.5 pounds of Foamaster 11, and 9 pounds of 15% sodium hydroxide in water. These formulations are indicated by TEW−463 below. A second formulation followed suggested practices for the use of Acrysol QR-708 thickener and is indicated by TEW−464.

| Formula No. | Thickener Composition |
|---|---|
| TEW-463-2 | 25%:75% CAM 9010 to nanoclay by weight |
| TEW-463-3 | 50%:50% CAM 9010 to nanoclay by weight |
| TEW-463-4 | 75%:25% CAM 9010 to nanoclay by weight |
| TEW-463-5 | 100% CAM 9010 by weight |
| TEW-464 | Acrysol QR-708 Standard |

In each formulation, excluding the QR-708 standard, the known potential activators in the coating include: ammonium hydroxide for the CAM 9010 and the boehmite acidity, the Tamol 731 pigment dispersant, and the sodium nitrite flash rust inhibitor for the nanoclay.

For testing, each coating was applied via Bird Bar drawdown to a dry film thickness of 2.5-3.0 mils at the formulated coating viscosity, without reduction of pH. As understood in the art, a Bird Bar is a generally known apparatus for providing a sample testing film. The substrate selected for most facets of testing was bare cold rolled steel. For testing of sag resistance, flow and leveling, etc., sealed Leneta charts were employed. All coated panels were then allowed to dry/cure for 14 days at room temperature conditions of 72 F and 45% R.H.

The evaluation of thickener efficiency and thickener impact on coating performance was then evaluated utilizing the following test methods.

| | |
|---|---|
| Viscosity (K.U.) | ASTM D562 |
| Viscosity (cps) | ASTM D2196 |
| Viscosity (ICI) | ASTM D4287 |
| Flow and Leveling | ASTM D2801 |
| Leneta Sag Resistance | ASTM D4400 |
| Film Thickness (DFT) | ASTM D1186 |
| Speed of Dry | ASTM D1640 |
| Hardness Development | ASTM D3363 |
| Specular Gloss | ASTM D523 |
| Adhesion (cross-hatch) | ASTM D3359 (method B) |

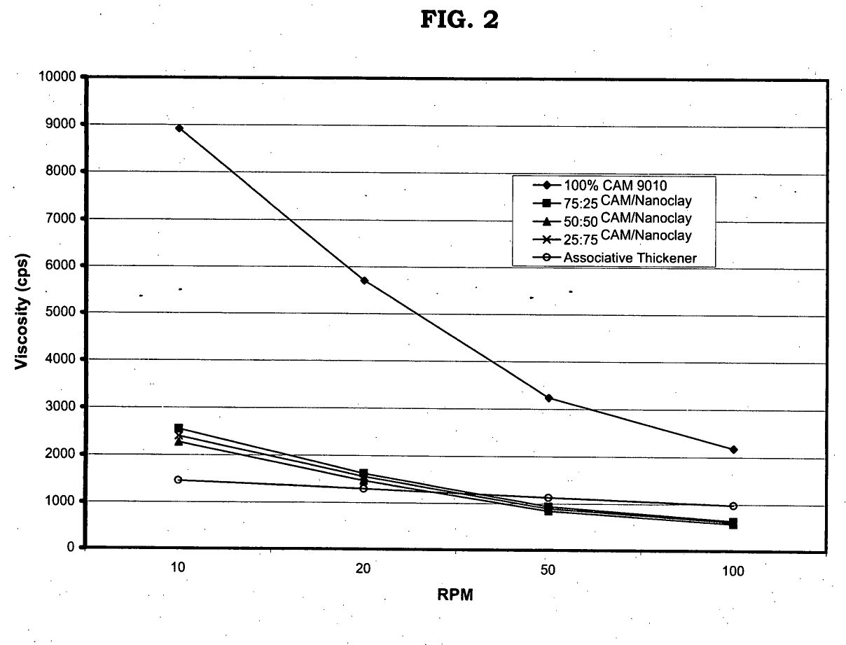

TABLE 1, shown below, depicts the viscosity, pH, sag resistance, and flow and leveling characteristics for the formulations. Each of the formulations exhibited a reduction in viscosity for increasing shear rates. However, the boehmite formulations exhibited a significantly higher low-shear viscosity than the QR-708 formulation (free of boehmite). In addition, each of the boehmite formulations exhibited a greater percentage drop in viscosity from low-shear to high-shear measurement than the QR-708 formulation. Indeed, as shown by the rheology profile in FIG. 2, the 100% CAM 9010 solution exhibited a high-shear viscosity that was less than 30% of the low-shear viscosity, representing a marked spread in viscosities.

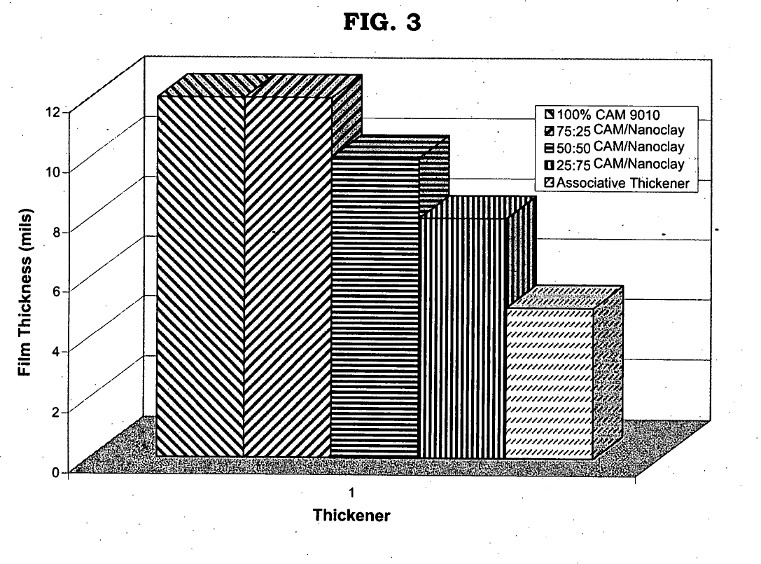

Data from sag resistance testing are depicted in FIG. 3. Each of the boehmite formulations exhibited a sag resistance greater than 7 mils. Samples TEW−463-2 through TEW−463-5 exhibited sag resistance of between 8 and 12 mils. The boehmite formulations also exhibit desired flow and leveling characteristics, having a flow and leveling above 6 mils and, in several examples, between 6 and 10 mils or between 6 and 7 mils.

Set-to-Touch Dry times for the boehmite formulations decreased with increasing percentages of CAM. The Set-to-Touch dry times decreased from 30 minutes to 9 minutes, as shown in TABLE 2. The surface dry time of the CAM formulations were also better than the QR-708 formulation.

The above-disclosed subject matter is to be considered illustrative, and not restrictive, and the appended claims are intended to cover all such modifications, enhancements, and other embodiments, which fall within the scope of the present invention. Thus, to the maximum extent allowed by law, the scope of the present invention is to be determined by the broadest permissible interpretation of the following claims and their equivalents, and shall not be restricted or limited by the foregoing detailed description.

TABLE 1

| | TEW- | TEW- | TEW- | TEW- | TEW- |
|---|---|---|---|---|---|
| PROPERTY | 463-2 | 463-3 | 463-4 | 463-5 | 464 |
| Viscosities | | | | | |
| cps | | | | | |
| 10 rpm | 2400 | 2270 | 2550 | 8920 | 1460 |
| 20 rpm | 1560 | 1470 | 1625 | 5700 | 1300 |
| 50 rpm | 896 | 848 | 940 | 3240 | 1132 |
| 100 rpm | 618 | 580 | 641 | 2180 | 982 |
| Kreb Units | 72 | 68 | 68 | 72 | 76 |
| ICI cone & plate | 0.70 | 0.80 | 1.00 | 1.60 | 0.60 |
| pH | 8.57 | 5.45 | 8.36 | 8.43 | 8.90 |
| Sag Resistance (mils) | 8 | 10 | 12 | 12 | 5 |
| Flow and Leveling (mils) | 6 | 6 | 7 | 10 | 4 |

TABLE 2

| | TEW- | TEW- | TEW- | TEW- | TEW- |
|---|---|---|---|---|---|
| PROPERTY | 463-2 | 463-3 | 463-4 | 463-5 | 464 |
| Dry Times | | | | | |
| Set-to-Touch (min.) | 30 | 15 | 12 | 9 | 50 |
| Surface Dry (min.) | 60 | 60 | 35 | 60 | 75 |

1. A surface coating solution comprising:
a surface coating base; and
boehmite particles provided in the surface coating base, the boehmite particles comprising mainly anisotropically shaped particles having an aspect ratio of at least 3:1.

2. The surface coating solution of claim 1, wherein the surface coating base is a water-based solution.

3. The surface coating solution of claim 2, wherein the water-based solution further comprises polymers in an emulsion, the surface coating solution being latex paint.

4. The surface coating solution of claim 3, wherein the latex paint comprises an acrylic.

5. The surface coating solution of claim 1, wherein the surface coating solution has flow and leveling of at least about 6 mils.

6. The surface coating solution of claim 1, wherein the surface coating solution has a sag resistance greater than about 7 mils.

7. The surface coating solution of claim 6, wherein the surface coating solution has a sag resistance between about 7 and 12 mils.

8. The surface coating solution of claim 1, wherein the surface coating solution is essentially free of associative thickener.

9. The surface coating solution of claim 1, wherein the boehmite particles constitute between about 0.1% and 20% by weight of the surface coating solution.

10. The surface coating solution of claim 9, wherein the boehmite particles constitute between about 0.5% and 10% by weight of the surface coating solution.

11. The surface coating solution of claim 10, wherein the boehmite particles constitute between about 0.5% and 2% by weight of the surface coating solution.

12. The surface coating solution of claim 1, wherein the surface coating solution has a set-to-touch dry time less than about 30 minutes.

13. The surface coating solution of claim 1, wherein the boehmite particles have a longest dimension of at least about 50 nanometers.

14. The surface coating solution of claim 13, wherein the boehmite particles have a longest dimension of between 100 and 1000 nanometers.

15. The surface coating solution of claim 1, wherein said aspect ratio is not less than about 6:1.

16. The surface coating solution of claim 1, wherein the boehmite particles have a secondary aspect ratio of not greater than about 3:1.

17. The surface coating solution of claim 1, wherein the boehmite particles have a surface area as measured by the BET technique of at least 10 m²/g.

18. The surface coating solution of claim 17, wherein the boehmite particles have a surface area as measured by the BET technique of at least 75 m²/g.

19. The surface coating solution of claim 18, wherein the boehmite particles have a surface area as measure by the BET technique between about 100 and about 350 m²/g.

20. The surface coating solution of claim 1, wherein the surface coating solution recovers 80% of low shear viscosity in less than about 15 seconds.

21. The surface coating solution of claim 1, wherein the pH of the solution is greater than 7.0.

22. A surface coating solution comprising boehmite particles comprising mainly anisotropically shaped particles having an aspect ratio of at least about 3:1 and a longest dimension of at least 50 nanometers.

23. The surface coating solution of claim 22, wherein the surface coating solution has flow and leveling greater than about 6 mils.

24. The surface coating solution of claim 22, wherein the surface coating solution has a sag resistance of at least 7 mils.

25. The surface coating solution of claim 22, wherein the surface coating solution is essentially free of associative thickener.

26. The surface coating solution of claim 22, wherein the boehmite particles constitute between about 0.5% and 2% by weight of the surface coating solution.

27. The surface coating solution of claim 22, wherein the surface coating solution has a set-to-touch dry time less than about 30 minutes.

28. The surface coating solution of claim 22, wherein the boehmite particles have a longest dimension of between 100 and 1000 nanometers.

29. The surface coating solution of claim 22, wherein the boehmite particles have at least a 6:1 aspect ratio.

30. The surface coating solution of claim 22, wherein the boehmite particles have a secondary aspect ratio of no more than about 3:1.

31. The surface coating solution of claim 22, wherein the boehmite particles have a surface area as measured by the BET technique of at least 10 m²/g.

32. The surface coating solution of claim 31, wherein the boehmite particles have a surface area as measured by the BET technique of at least 75 m²/g.

33. The surface coating solution of claim 32, wherein the boehmite particles have a surface area as measure by the BET technique between about 100 and about 350 m²/g.

34. The surface coating solution of claim 22, wherein the surface coating solution recovers 80% of low shear viscosity in less than about 15 seconds.

35. A method of forming a surface coating preparation, the method comprising:
activating boehmite particles to form an active solution, the boehmite particles comprising mainly anisotropically shaped particles;
forming a grind solution using the active solution; and
forming a coating preparation using the grind solution.

36. The method of claim 35, wherein activating boehmite particles results in the active solution having shear thinning rheology.

37. The method of claim 35, wherein activating boehmite particles comprises adding a base.

38. The method of claim 37, wherein the base is ammonium hydroxide.

39. The method of claim 35, wherein activating boehmite particles comprises increasing pH of the active solution to at least 7.0.

40. The method of claim 35, wherein activating boehmite particles comprises adding particles having a charge opposite to that of the boehmite particles.

41. The method of claim 35, wherein forming the grind solution comprises adding a pigment.

42. The method of claim 35, wherein activating boehmite particles comprises adding a salt.

43. The method of claim 35, wherein the mainly anisotropically shaped particles have an aspect ratio of at least about 3:1.

44. The method of claim 35, wherein the coating preparation has flow and leveling greater than about 6 mils.

45. The method of claim 35, wherein the coating preparation has sag resistance of at least 7 mils.

46. The method of claim 35, wherein the coating preparation is essentially free of associative thickener.

47. The method of claim 35, wherein the boehmite particles comprise between about 0.5% and 2% by weight of the coating preparation.

48. The method of claim 35, wherein the coating preparation has a set-to-touch dry time less than about 30 minutes.

49. The method of claim 35, wherein the boehmite particles have a longest dimension of at least about 50 nanometers.

50. The method of claim 35, wherein the boehmite particles have a surface area as measured by the BET technique of at least 10 m²/g.

51. The method of claim 35, wherein the coating preparation recovers 80% of low shear viscosity in less than about 15 seconds.

52. A surface coating preparation formed by the method of claim 35.
